(19) United States
(12) Patent Application Publication
(10) Pub. No.: US 2006/0028014 A1
(43) Pub. Date: Feb. 9, 2006

(54) Peel-off label and methods of utilizing the same

(75) Inventors: Thomas P. McQueeny, Chicago, IL (US); James M. Irish, San Diego, CA (US)

Correspondence Address: MARSHALL, GERSTEIN & BORUN LLP, 233 S. WACKER DRIVE, SUITE 6300, SEARS TOWER, CHICAGO, IL, 60606, US

(73) Assignee: IMPAQ, INC.

(21) Appl. No.: 11/130,668

(22) Filed: May 16, 2005

Related U.S. Application Data
(60) Provisional application No. 60/571,433, filed on May 14, 2004.

(51) Int. Cl. B42D 15/00

(52) U.S. Cl. 283/101

(57) ABSTRACT

A beverage bottle label that includes a first panel manufactured from a first stock material that has a first side displaying a first group of product information and a second side displaying a second group of product information that is different from the first group of product information. The beverage bottle label further includes a second panel manufactured from a second stock material that is different from the first stock material and includes a first side displaying the first group of product information. The first panel and the second panel are releasably secured using a dry-peel adhesive, and the second panel accepts an adhesive adapted to secure the second panel to a product.

### CROSS REFERENCE TO RELATED APPLICATIONS

This patent claims the priority benefit of U.S. provisional patent application Ser. No. 60/571,433, filed on May 14, 2004, titled “PEEL-OFF LABEL”, the disclosure of which is incorporated herein by reference.

### TECHNICAL-FIELD

The present invention relates generally to removable labels applied to beverage bottles and, more particularly, to a peel-off label applied to a beverage bottle and adapted to facilitate recollection of a beverage contained in the bottle, and to a method of manufacturing and marketing using such a peel-off label.

### BACKGROUND

The growing popularity of wines, specialty beverages and the like have greatly increased the types, brands, and varieties of beverages available to consumers. This abundance of choices can make it difficult for consumers to recollect the information necessary to reacquire previously sampled beverages. Specifically, it can be difficult to recall the vintage, vineyard and varietal of a specific wine after it has been consumed and the bottle has been discarded.

Recollection of a previously consumed wine benefits a vineyard in the form of increased sales and brand recognition. Further, the ability to recollect beverage or wine benefits consumers by allowing them to continue to enjoy favorite wines and beverages after their initial sampling of these beverages. Thus, it is desirable for all parties involved in the production, sales and consumption of wine and other beverages to have a system for facilitating recollection of wine or other consumed beverages.

A known method of recollection involves permanently attaching a sheet material to a liquor bottle. The sheet material, which may be written upon, includes an anchor portion, and has detachable parts connected to the anchor portion. The detachable parts are not directly attached to the liquor bottle, and thus the detachable parts may be detached individually from the bottle in order to memorialize the storage and movement of the liquor bottle.

Another known method of recollection describes a system for organization, inventory control, and reordering of hardware items that includes a label attached to a face of a carton. The label includes one portion that displays indicia representing the particular hardware item stored in the carton, e.g. a drawing of the hardware type, a description of the contents, and quantity. Each label also has a detachable perforated portion that can be peeled off from the carton and reaffixed to another object using a reusable pressure-sensitive backing. Thus, when a carton is low, the user simply removes the perforated portion of the label from the face of the carton and affixes it to the order form to complete the order.

Yet another known method of recollection includes a removable label applicable to the wine bottle. The label is removable and is capable of placement on a memorandum of the transaction by which the user acquired the wine, such as a sales slip or other receptacle. The label can be attached to the bottle with reusable glue or other reusable means, such as Velcro®.

Still other known methods involve peeling or cutting the beverage labels from the surface of a bottle using a knife, adhesive tape, etc. Another known method is for the consumer to simply retain the bottle of the label in place.

### BRIEF DESCRIPTION OF THE DRAWINGS

For a more complete understanding of the invention, reference should be made to the following detailed description and accompanying drawings wherein:

FIG. 1 is a perspective view illustrating a beverage bottle such as a wine bottle incorporating a peel-off label assembled in accordance with the teachings of the present invention;

FIG. 2 is a cross-sectional view of the peel-off label and the beverage bottle taken along section line 2-2;

FIG. 3 is an elevational view showing the first side of the first panel of the peel-off label shown in FIG. 1;

FIG. 3A is an elevational view showing the second side of the first panel of the peel-off label shown in FIG. 1;

FIG. 4 is an elevational view showing the second panel of the peel-off label shown in FIG. 1;

FIG. 5 is an elevational view of an alternate embodiment for the first panel of the peel-off label;

FIG. 5A is an elevational view of another alternate embodiment of the peel-off label;

FIG. 6 is a perspective view similar to FIG. 1 and showing the peel-off label partially separated from the beverage bottle;

FIG. 7 is a flow chart detailing an exemplary production routine utilized during the manufacture of the exemplary peel-off label shown in FIG. 1;

FIG. 8 illustrates an alternate embodiment of a peel-off label affixed to a print medium;

FIG. 9 illustrates the peel-off label shown in FIG. 8 partially separated from the print medium;

FIG. 10 illustrates an enlarged view of the peel-off label shown in FIG. 9; and

FIG. 11 is a flow chart detailing an exemplary production routine utilized during the manufacture of the exemplary peel-off label and print medium shown in FIG. 8.

### DETAILED DESCRIPTION

Although the following text sets forth a detailed description of exemplary embodiments of the invention, it should be understood that the legal scope of the invention is defined by the words of the claims set forth at the end of this detailed description. The detailed description is to be construed as exemplary only and does not describe every possible embodiment of the invention since describing every possible embodiment would be impractical, if not impossible. Numerous alternative embodiments could be implemented, using either current technology or technology developed after the filing date of this patent, all of which would still fall within the scope of the appended claims.

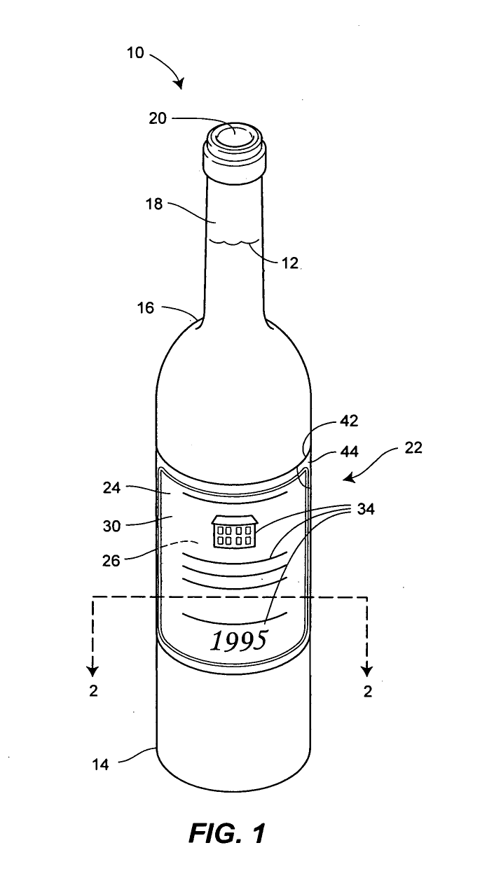

Referring now to the drawings, FIG. 1 illustrates a beverage bottle 10, which is typically filled or fillable with a liquid 12. The beverage bottle 10 includes an outer surface 14, and typically includes a substantially frusto-conical portion 16 that tapers into a neck 18. The neck 18 includes an opening 20 as would be conventional in order to fill or dispense the liquid 12 contained within the bottle 10. It will be understood that the size and material of the bottle 10 can be varied depending on, among other things, the amount of the liquid 12 to be contained in the bottle, or the anticipated storage conditions of the beverage bottle 10. The bottle 10 may be, in all respects, conventional. The beverage bottle 10 also includes a peel-off label assembly 22 assembled in accordance with the teachings of a disclosed example of the present invention. The peel-off label assembly 22 is attached to the outer surface 14 of the bottle 10 in a manner to be described in greater detail below.

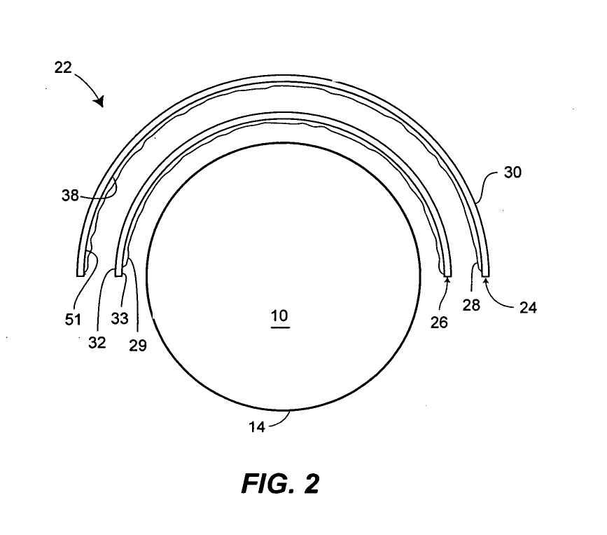

The peel-off label assembly 22 includes a first panel 24 which, in the disclosed example, is substantially superimposed over a second panel 26 (obscured in FIG. 1 by the first panel 24, but visible in FIGS. 2 and 4). The first panel 24 includes an outer or first side 30, and indicia 34 is printed or otherwise formed on the first side 30 of the first panel 24. The indicia 34 may include text, graphics, and/or product information, or other suitable information for printing on the label assembly. The panel 26 also preferably includes indicia 36 (visible in FIG. 4 and discussed below). Again, the indicia 36 may include text, graphics, and/or product information, or other suitable information for printing on the bottle 10.

Referring now to FIG. 2, the peel-off label assembly 22 is shown in slightly exploded form with the peel-off label assembly 22 shown spaced away from the bottle 10, and with the first panel 24 shown spaced away from the second panel 26. The first panel 24 includes an inner or second side 38 in addition to the outer or first side 30 discussed above. The second panel 26 includes an outer or first side 32 and an inner or second side 33. And adhesive layer 28 is applied to the second side 38 of the panel 24 so as to secure the second side 38 of the panel 24 to the outer side 32 of the panel 26. As an alternative, the adhesive layer 28 may be applied to the outer side 32 of the panel 26, or in any other arrangement that permits the panel 24 to be secured to the panel 26. Another adhesive layer 29 is attached to the inner side 33 of the panel 26, so as to permit the inner side 33 of the panel 26 to be attached to the outer perimeter of the bottle 10. As an alternative, the adhesive layer 29 may be applied directly to the outer surface of the bottle 10, or in any other arrangement that permits the panel 26 to be secured to the bottle 10. The adhesive layers 28 and 29 also may be pressure sensitive adhesives.

In accordance with the disclosed example, the adhesive layer 28 is preferably a dry-peel adhesive product. The dry-peel adhesive product also may be referred to by those of skill in the art as a dry-tack adhesive or as a dry-release adhesive. A dry-peel adhesive product is used to provide a releasable adhesive bond between to panels, substrates, or other items. This releasable adhesive bond, once released, does not have residual tackiness. Accordingly, once the original bond is released, the dry-peel adhesive product remaining on one or both of the panels is dry and is not sufficient to form a new bond if a user attempts to attach one or both of the panels to another surface. One such dry-peel adhesive for laminating the panels together may be a fugitive water-based adhesive available National Starch & Chemical. Another potential adhesive is available from Beacon Adhesives Company of Mount Vernon, New York, under the trade name MAGNA-CRYL 6551, and is described as a fugitive adhesive designed to temporarily laminate two substrates. Similar to a removable adhesive, a fugitive adhesive temporarily adheres two substrates but leaves no tack and residue once the substrates have been separated. Other suitable dry-peel adhesives may be obtained from 3M Corporation, under a variety of trade names. Thus, it will be understood that the adhesive 28 forms a removable or releasable bond between the inner surface 38 of the panel 24 and the outer surface 32 of the panel 26. Those of skill in the art will readily understand matching the piece of to be substrates to be joined or laminated may involve some degree of trial and error, as different films, substrates, papers etc. are more suitable for joining more laminating use one adhesive as opposed to another. One of skill in the art of label making can, based on the selected substrates, and based upon a reading of this specification, readily choose the best adhesive.

Typically, the adhesive 28 may be applied in a liquid form and, upon drying, forms the releasable bond between the two panels 24 and 26. Upon destruction of this releasable bond, which happens upon the removal of the panel 24 from the panel 26 as will be outlined in greater detail below, the dry-peel or dry-release adhesive cannot be used to reattach the removed panel 24 to anything else, because any residue remaining from the original bond after the panel 24 has been separated from the panel 26 simply is not sufficient to form another bond. Similarly, there is little or no is residue on the outer side 32 of the panel 26 sufficient to stick anything else onto the outer side 32 of the remaining panel 26.

The adhesive 29 is preferably the type of adhesive conventionally used to attach a label to a beverage bottle. Such conventional adhesives are well known in the art. As would also be known, the adhesive 29 is intended to form a “permanent” bond between the panel 26 of the peel-off label assembly 22. Although this bond may be referred to herein as “permanent,” those of skill in the art will readily understand that consumers have long attempted to, and succeeded at, removing conventional, single-panel labels that have been “permanently” attached from beverage bottles (as is outlined above in the Background of the Invention section of this specification).

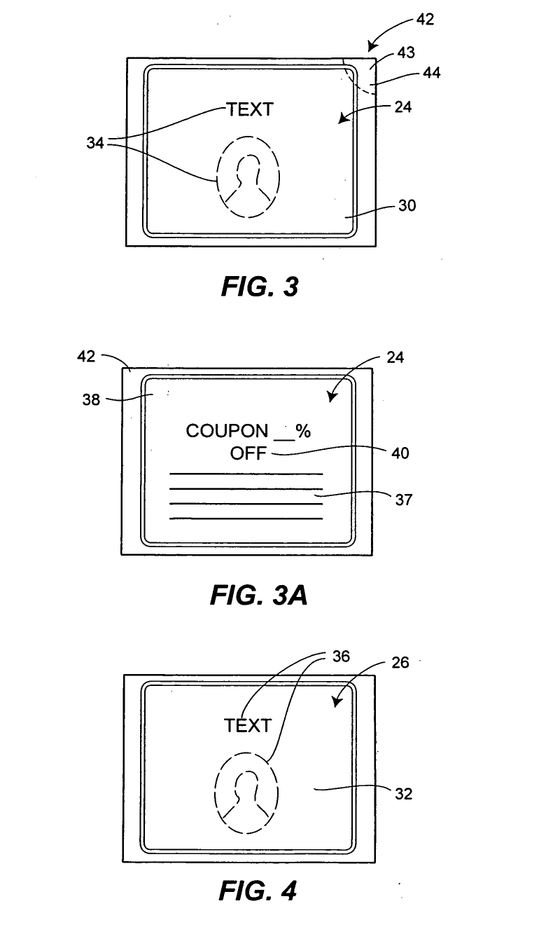

As shown in FIGS. 3 and 4, in accordance with the disclosed example, the first panel 24 and the second panel 26 are substantially the same size and shape, such that when the first panel 24 is superimposed over the second panel 26, the two panels appear to form a single label or label structure. Again, it will be understood that the first panel 24 and the second panel 26 are releasably bonded together by the adhesive layer 28 as discussed above. The resulting two piece peel-off label assembly 22 can be secured to the outer surface 14 of the beverage bottle 10 using the adhesive layer 29.

Referring still to FIGS. 3 and 4, the indicia 34 is located on the first side 30 of the panel 24, and the indicia 34 preferably is printed on the first side 30 using conventional printing techniques of the type commonly employed in the printing of labels for beverage bottles. Other techniques may prove suitable. The indicia 36 is printed on the side 32 of the panel 26, and again the indicia 36 preferably is printed on the side 32 using conventional printing techniques of the type commonly employed in printing labels for beverage bottles. Once again, other techniques may prove suitable.

In accordance with the disclosed example, and depending on the type of liquid 12 stored or contained within the beverage bottle 10, the indicia 34, 36 may take the form of product information of the type that may be required by law. For example, the indicia 34 and 36 may take the form of product information intended to comply with applicable government regulations, such as, for example, federal regulations established by the United States Alcohol Tobacco and Trade Bureau (TTB). In further accordance with the disclosed example, the indicia 34 and the indicia 36 may be identical or substantially identical. Consequently, the indicia 36 that remains on the panel 26 after the panel 24 has been removed is the same (or substantially similar) as the indicia 34 originally visible to a viewer prior to the removal of the panel 24. For example, if the liquid 12 contained within the bottle 10 is wine, then the indicia 34 and 36 may include, by way of example rather than limitation, the brand of the wine, the alcohol content, the address of the wine source, the amount of wine, content information, the country of origin, and a health disclaimer.

In accordance with the disclosed example, by duplicating or substantially duplicating the indicia 34, 36 on both of the first and second panels 24, 26, the peel-off label assembly 22 aids consumers in recollecting aspects of the liquid 12 originally contained in the bottle 10. For example, if a consumer enjoys a bottle of wine, the first panel 24 can be removed from the bottle 10 by detaching the first panel 24 from the second panel 26, thus breaking the original bond formed by the piece of 28. The removable panel 24, by virtue of the indicia 34, allows the consumer to keep a complete copy of the indicia 34 related to the wine. As stated above, the indicia 34 contains various product information indicative of the wine originally contained in the bottle 10.

Referring now to FIG. 3A, the second side 38 of the panel 24 is shown. The second side 38 of the panel 24 includes indicia 40. The indicia 40 may include various information such as, by way of example rather than limitation, product information of the type discussed above with respect to the indicia 34 and 36. Still further, the indicia 40 may include a marketing device such as a coupon, an advertisement, an award, etc. Thus, should the indicia 40 take the form of marketing devices, the indicia 40 can then cross-promote another good and/or service that may be or interest to the consumer who purchased the bottle 10. For instance, if the liquid 12 contained with the beverage bottle 10 is wine, the product information 40 could be a coupon or discount for cheese, stem ware, or future wine purchases from a particular vendor, retailer, etc. However, if the liquid 12 contained within the bottle 10 is beer, then the indicia 40 may include product information that relates to, for example, snack foods, sporting events, party supplies, etc. Consequently, the peel-off label assembly 22 can, in accordance with the disclosed example, be used to tie and market related products and services. As a still further alternative, the indicia 40 may be used to tie and market unrelated products and services. It will be understood that if required, the indicia 40 can be adapted in order to comply with applicable legal standards, such as the above-referenced TTB labeling requirements. As a further alternative, the side 38 of the panel 24 may be adapted so as to provide a space 37 for the consumer to make a written record, such as tasting notes regarding the wine or other liquid 12, notations regarding special events attended while consuming the liquid 12, etc. In any event, it will be appreciated that the indicia 40 typically is not visible to an observer until after the panel 24 has been removed from the panel 26.

The peel-off label assembly 22 preferably includes a handle assembly 42. A handle assembly 42 enables the user to grasp the panel 24 in order to remove the panel 24 from the underlying panel 26. A handle assembly 42 may take a number of forms. For example, and referring now to FIG. 3, a handle assembly 42 may be formed by a hold-out area 43. The hold-out area 43 is an area disposed in between the panels 24 and 26 in which the adhesive layer 28 has not been applied. Thus, the hold out area 43 is an area formed by a void or absence of the glue or the dry-release adhesive used as the adhesive 28. The position of hold-out 43 between the first and second panels 24, 26 may vary, but, in the example shown in FIG. 3, the hold out area 43 is located at the upper right and corner of the panel 24. Of course the actual location may vary. It will be appreciated that the hold out area 43 thus forms a pull tab 44. The pull tab 44 may be printed to indicate the presence of the pull tab 44, Such as by printing the words “peel away” or the like on the side 30 of the panel 24 at the appropriate location.

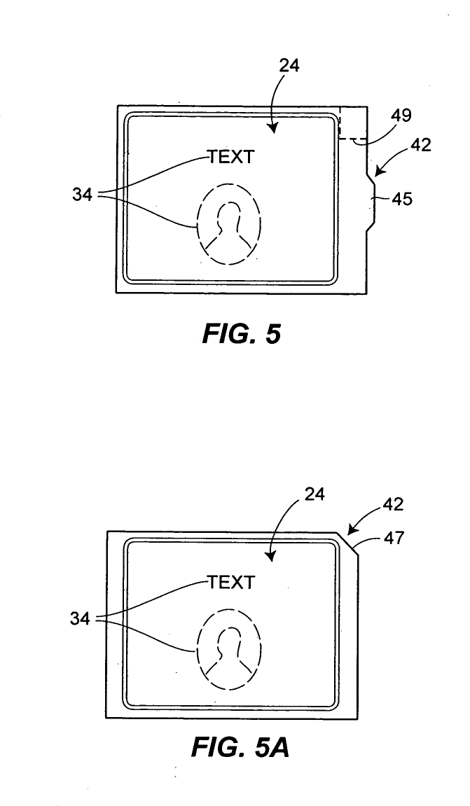

Alternatively, and referring now to FIG. 5, the handle assembly 42 may take the form of a tab 45 formed on the first panel 24. In a sample shown, and tab 45 extends from an edge of the panel 24, and more specifically extends from the right edge of the panel 24 when viewing the Figure. Any event the tab 45 is provided, the need for the holdout 43 may be eliminated. However, it will be understood that a hold out area may still be provided generally adjacent to the tab 45 in order to facilitate easy removal of the panel 24 from the underlying panel 26.

Referring now to FIG. 5A, and all assembly 42 may take the form of a notch 47 defined in the first panel 24 and positioned to assist the user in grasping the first panel 24 in order to separate the first panel 24 from the second panel 26. Is another alternative, the underlying panel 26 may include a notch 49 (illustrated and FIG. 5) underlying the superimposed panel 24.

Each of the foregoing handle assemblies 42 provides a way for the consumer to grasp and separate the first panel 24 from the second panel 26: It will be appreciated that, in addition to specific constructions shown, the handle assembly 42 may take other suitable forms.

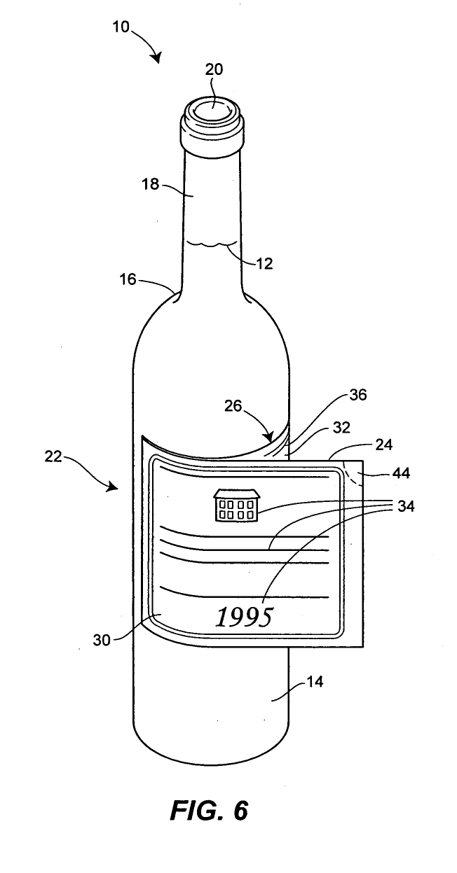

FIG. 6 illustrates the beverage bottle 10 carrying the peel-off label assembly 22. As shown, the first panel 24 has been partially separated from the underlying second panel 26. In particular, the handle assembly 42 (in this case the holdout 43 forming the pull tab 44) has apparently been grasp and pulled such that the panel 24 is partially peeled away from the underlying panel 46. It will be understood that, in the process of pulling the panel 24 away from the panel 26, at the bond formed by the pieces 28 disposed between the panels 24, 26 has been broken.

Of course the indicia 34 contained on the side 30 of the panel 24 has been readily visible to an observer. It will be understood that, upon removal of the first panel 24 from the second panel 26, the indicia 36 printed on the panel 26 now becomes visible to the observer. Also, removal all the panel 24 from the panel 26 enables the observer to view the indicia 40 printed on the side 38 of the panel 24. As discussed above, if the act of peeling away the first panel 24 from the second panel 26 releases or destroys the original bond formed by the adhesive layer 28.

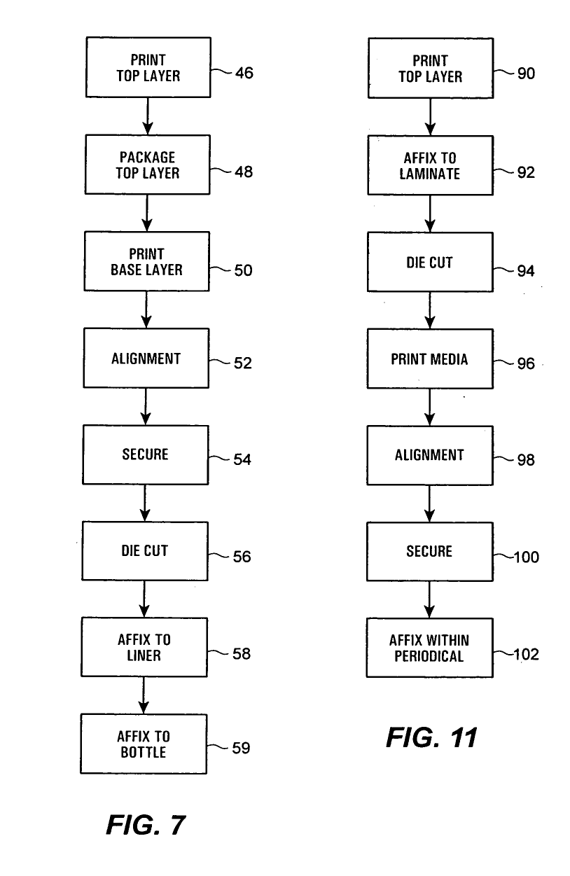

FIG. 7 is a flow chart detailing an exemplary production routine that can be utilized during the manufacture of the peel-off label assembly 22 shown in FIGS. 1-6. While the production routine discussed herein focuses on the printing and manufacture of peel-off wine labels, it will be understood that this exemplary production process is intended to simply provide an overview and discussion of one set of tasks and steps that can be performed during the printing and manufacture of the peel-off label assembly 22.

At a block 46, the process begins with printing the first panel 24. The first panel 24 is typically the standard wine label currently known and used by vineyards or bottlers. The first panel 24 may be manufactured from a variety of materials such as, for example, rolls of Estate stock No. 8, linen stock, including linen stock that can be embossed or foiled in any desired manner. The first panel 24 may further be formed at any other suitable label material has commonly employed in the art of applying labels to beverage bottles such as wine bottles. As discussed above in connection with FIGS. 1 and 2, the first panel 24 is a double-sided label printed on a first side 30 to include the indicia 34, and is also printed on the second side 38 to include the indicia 40.

The indicia 34 is generally printed in a 6-8 color printing process that provides for the fine detail and clarity desirable for product label, and especially for wine bottle labels. The indicia 40, which is printed on the reverse or second side 38 of the first panel 24, is preferably printed in a more economical 2 color printing process, although the 6-8 color printing process may be employed. Depending on the characteristics of the chosen material for the panel 24, and depending on the colors used in printing the indicia 34, it may be necessary to print or otherwise apply a coating 51 to the second side 38 of the panel 24 using a transparent, translucent, or opaque, or partially opaque ink. The additional opaque ink coating 51 prevents the indicia on one side of the panel 24 from bleeding through and being visible on the other side of the panel 24. The coating typically is applied before the panel is printed. Because of the wide variety of possible label materials and/or colors used in the process of applying the indicia, one or more test runs may be required in order to choose the proper coating 51 in order to satisfy the printer of the labels. It will be understood that the coating 51 may not be required in all circumstances.

Continuing with FIG. 7, at a block 48, the completed double-sided first panel 24 is packaged or arranged for further processing. In particular, the roll material upon which the indicia 34, 40 is printed can be wound and gathered onto a spindle. Alternatively, the double-sided first panel 24 can be cut into individual labels after the multiple printing operations are complete. The individual labels or first panels 24, in turn, are gathered and stacked within a cartridge for use in later processing steps. It will be understood that for sake of simplicity, the double-sided first panel 24 will typically not include an adhesive layer or adhesive back thereby eliminating the need for an additional liner. However, as an alternative, the panel 24 may be coated with the adhesive 28 as required and provided with an additional liner if desired.

At a block 50, the second panel 26 is printed on an underlying roll stock such as a coated one side material (hereinafter referred to as “C1S”). The C1S based second panel 26 may be printed in a manner similar to the printing process used to print the first panel 24. In particular, the indicia 36 printed on the first side 30 of the second panel 26 preferably is applied in a 6-8 color printing process that provides for the fine detail and clarity desirable for product labels such as wine labels. As would be known, the C1S stock material is engineered to accept printing as described above and the permanent adhesive layer 29 for bonding to the outer surface 14 of the beverage bottle 10. The printing and adhesive application using the C1S stock for the panel 26 all may be accomplished using conventional label making techniques.

At a block 52, the roll of double-sided first panel 24 and the roll of C1S-based second panel 26 are prepared for attachment to one another. It will be understood that the second panel 26 can be printed and aligned with the completed first panel 24 in a single process, however the steps are described separately for the sake of clarity. In order to aid in alignment between the first and second panels 24, 26 such that the panels 24 and 26 are substantially superimposed, the printed indicia 34, 36 may include a visual marker or aid that can be detected by a recognition device such as a camera. The recognized visual marker on the first panel 24 can be correlated with the recognized visual marker on the second panel 26 based on, among other things, the relative location of the cameras, the speed at which the two rolls of labels are being process within the equipment and the relative location of the markers within the printed indicia 34, 36. Once the positions of the recognized markers are positively established relative to one another, the first and second panels 24, 26 are considered to be aligned. Alternatively, alignment can be performed using perforations formed at precise locations within each of the rolls of labels.

At a block 54, the aligned first and second panels 24, 26 are secured together via the adhesive layer 28. Once the adhesive 28 of the adhesive layer 28 is dry and has set, the first panel 24 and the second panel 26 are releasably secured together in an aligned manner, as described above. The adhesive layer 28 can be applied, for example, as a continuous film or in a pattern that includes the hold-out 42 (see for example FIGS. 2 and 3). It is known to gather empirical data as the production process is established to indicate the amount and style in which the adhesive layer 28 should be applied to facilitate the desired separation characteristics of the first panel 24 from the second panel 26. For example, the porosity differences between the stock material of the two layers, e.g., Estate stock No. 8 and C1S, can change the effectiveness of the dry-release adhesive used to bond the first panel 24 to the second panel 26 thereby requiring changes in amount of adhesive applied in the adhesive layer 28. The gathering of such empirical data is normally encountered in the art and is readily resolvable by one of skill any art.

At a block 56, the bonded first panel 24 and second panel 26 are die cut to the desired final shape. Specifically, the bonded first panel 24 and second panel 26 are aligned relative to a cutting punch and die (not shown) and are separated from the excess roll stock material upon which they were originally printed. At this point, the assembled peel-off label assembly 22 appears similar to a standard wine label of the type currently known and used by vineyards or bottlers and may be handled as such.

At a block 58, the separated peel-off label assembly 22 including the first and second panels 24, 26 is affixed to a liner (not shown) via the adhesive applied to the C1S material of the second panel 26. The resulting liner and peel-off label assembly 22 combination is wound around a spindle to produce a continuous roll of labels ready for attachment to the beverage bottle 10. It should be noted that the continuous rolls of labels are typically arranged such that the peel-off labels 22 have an inward or concave curvature. The inward or concave curvature helps to prevent undesirable separation of the bonded first panel 24 and second panel 26 from each other and/or the liner. Typically it is desirable to limit the minimum external bend radius experienced by the peel-off labels 22, such as, for example, during the application or bottling process, to 2 or 3 inches.

The liner may be conventional, such as a forty (40) lb. or fifty (50) lb. liner. Eventually, the label assembly 22 will be peeled-off the liner in preparation for applying the label assembly 22 to the bottle. When the label assembly 22 is peeled-off the liner, the adhesive 29 is “live.” Referring still to FIG. 7, at a block 59, the peel-off label assembly 22 and the associated liner (not shown) may be mounted on the appropriate bottling or packaging equipment for placement on the beverage bottle 10. In particular, during the placement process the beverage bottle 10 will typically be revolved along its longitudinal axis relative to allow the peel-off label assembly 22 to be spun onto the external surface of the outer surface 14. The resulting labeled beverage bottle 10 is ejected from the packaging equipment and the liner can be recycled or discarded.

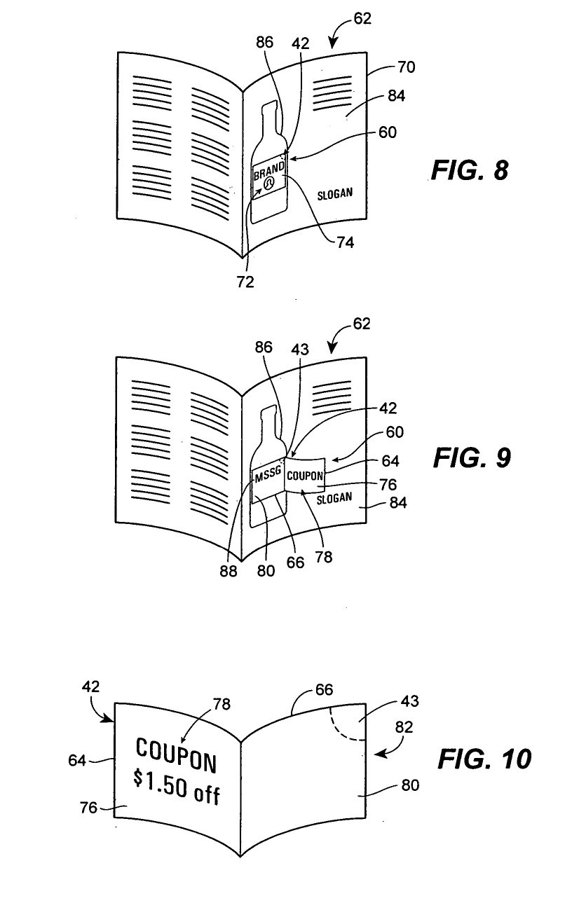

FIGS. 8 and 9 illustrate an alternate embodiment of a peel-off label assembly 60 which, in the example of FIGS. 8 and 9, has been affixed to a print medium generally indicated by the reference numeral 62. The peel-off label assembly 60 includes an outer or first panel 64 and an inner or second panel 66. The print medium 62 of the present embodiment may be, for example, a magazine including, for example, a printed text page 68 and a printed media page 70. The text page 68 and the media page 70 can be two elements of a common article or can be unrelated items. Furthermore, the media page 70 can printed and bound along with multiple text pages 68 or can be a blow-in advertising that is inserted and bound in a separate step during the magazine production. Moreover, the media page 70 can be used independently as a flyer or card to advertise or promote beverage products.

The first panel 64, as discussed above in connection with the first panel 24, is typically manufactured from the same material used to produce standard bottle labels. For example, rolls of Estate No. 8 label stock are printed with indicia 72 on a first side 74 in a 6-8 color printing process. The label stock is further printed on a second side 76 with indicia 78 in, for example, a more economical 2 color printing process (see FIG. 10.) The indicia 78 can be, for example, a coupon for a discount on the product described by the indicia 72, or can be related to a cross-marketed third-party product, or to a related product, or to any other product. Regardless of the nature of the indicia 78, it may be necessary to preprint the second side 76 using an opaque ink prior to printing any information. As discussed above, the additional coating of an opaque ink (or a semi-opaque, semi-translucent, or other ink) may reduce or eliminate the indicia 78 and/or 72 from bleeding through and being visible on the opposite side of the panel.

The second panel 66 is a clear laminate layer, e.g., a common 0.001 mil clear laminate stock, which is transparent. The second panel 66 may be bonded or otherwise suitably releasably secured to the first panel 64 using an adhesive layer such as the adhesive layer 28 shown in FIG. 2. The adhesive layer 28 is applied between the first side 80 of the second panel 66 and the second side 76 of the first panel 64 so as to provide a releasable bond between the first panel 64 to the second panel 66. The second panel 66 may be securable to a surface 84 of the media page 70, such as by using the adhesive layer 29 discussed above with respect to the first disclosed example, or by using any other suitable adhesive. The adhesive 29 may be applied between a second side 82 of the panel 66 and the surface 84 of the media page 70, preferably by applying the adhesive 29 to the second side 82. Once again, as discussed above with respect to the first disclosed example, the peel-off label assembly 62 may be first assembled on a liner, and then applied to the media page after removal from the liner.

The peel-off label assembly 60 preferably includes a handle assembly 42, which preferably may be the same or similar to the handle assembly 42 discussed above with respect to the first disclosed example. The handle assembly 42 enables the user to grasp the panel 64 in order to remove the panel 64 from the underlying panel 66. As with the handle assembly 42 discussed above with respect to the first disclosed example, the handle assembly 42 of the peel-off label assembly 60 may take a number of forms, including any of the forms discussed above. In the example of FIGS. 8-10, the handle assembly 42 includes the adhesive holdout area 43.

In accordance with the example of FIGS. 8-10, the peel-off label assembly 60 may be assembled in a manner similar to the assembly of the first disclosed example discussed above. After the panel 64 has been printed on both sides, and the after the panel's 64 and 66 have been suitably joined using the adhesive 28, the connected panels may be attached to a liner as discussed above. As outlined above, the panel 66 may be transparent.

FIG. 11 is a flow chart detailing an exemplary production routine that can be utilized during the manufacture of the peel-off label 60 shown in FIGS. 8-10. At a block 90, the process begins with printing the first panel 64. The first panel 64 is typically the standard wine label currently known and used by vineyards or bottlers. As discussed above in connection with the exemplary first panel 24, the first panel 64 may be manufactured from a variety of materials such as, for example, rolls of Estate stock No. 8 and linen stock that can be embossed or foiled in any-desired manner. The first panel 64 is a double-sided label printed on a first side 74 to include the indicia 72 and a second side 76 to include the indicia 78.

At a block 92, the completed double-sided first panel 64 is mated or affixed to the clear laminate second panel 66. In particular, the first and second layers 64, 66 are secured together via the dry-release adhesive layer 28. As previously discussed, the dry release adhesive provides a bond between the first panel 64 and the second panel 66 that results in little or no tackiness or residue between the layers after they are separated by the consumer.

At a block 94, the bonded first and second layers 64, 66 are die cut to the desired final shape. Specifically, the bonded first panel 64 and second panel 66 are die cut to remove excess stock material and provide complete label that appears to be the standard wine label currently known and used by vineyards or bottlers rather than the two piece label shown in FIG. 3.

At a block 96, the media page 70 is printed or otherwise manufactured with the desired text or images. The printing may include a bottle graphic 86 intended to resemble the wine or beverage bottle 10 being sold or may include text, logos or any other desired advertising messages.

At a block 98, the media page 70 and the peel-off label 60 are prepared for attachment to each other. The media page 70 and the peel-off label 60 may be aligned relative to each other using a visual marker or aid that can be detected by a recognition device such as a camera. The recognized visual marker on the media page 70 can be correlated with the recognized visual marker on the peel-off label 60 based on, among other things, the relative location of the cameras, the speed at which the two components are being process within the equipment, etc. In this manner, the relative positions of the visual markers and the thus the media page 70 and the peel-off label 60 are established relative to each another.

At a block 100, the aligned peel-off label 60 including the first and second layers 64, 66 is affixed to the media page 70 via the permanent adhesive layer 29 applied to the second side 82 of the second panel 66 to secure the peel-off label 60 to a surface 84 of the media page 70. In particular, the peel-off label 60 will be secured to appear as an integral part of the bottle graphic 86 printed on the surface 84 of the media page 70.

At a block 102, the combination media page 70 and peel-off label 60 are secured or placed within a periodical, newspaper, pamphlet or other advertising medium. The combination media page 70 and peel-off label 60 may be a blow-in insert placed within the periodical or may be fixedly joined or bound during final manufacture or printing of the product.

Upon receipt of the periodical containing the combination media page 70 and peel-off label 60, the consumer can remove the first panel 64 by destroying the releasable bond formed by the dry release adhesive of the adhesive layer (not shown) to reveal indicia 78 or coupon printed on the second side 76. Once the first panel 64 has been removed, the clear second panel 66 allows the consumer to view the indicia 88 that was printed as an integral part of the bottle graphic 86. The indicia 72, 88 can be the same information or can, for example, be part of a promotional game where the consumer removes the first panel 64 to determine if they have won a prize.

While these exemplary peel-off label assemblies 22, 60 have been described herein as they relate to the distribution and advertisement of wine and wine products, it will be understood that these labels can be adapted for wide variety of products. For instance, the peel-off label assembly 22 can be affixed to a beer bottle and used to advertise related services and products, e.g., snack foods. Depending on the application, the dry release adhesive used in the peel-off label assembly 22 may be reformulated to prevent unintended separation caused by condensation gathering along the surface of the beverage bottle 10.

In addition to the construction described above, the label assemblies also may be constructed so as to be fed into a cassette-type feeder having its own glue bay for applying the glue that holds the label assembly to the bottle, and which may use a cold glue format.

Additional details concerning the manner by which a removable label may facilitate the recollection of wine consumed from a wine bottle may be found in co-pending U.S. patent application Ser. No. 10/392,045, entitled “Method of Facilitating Recollection of a Wine Consumed From a Bottle” filed Mar. 19, 2003, the entire disclosure of which is incorporated herein by reference.

Numerous modifications and alternative embodiments of the invention will be apparent to those skilled in the art in view of the foregoing descriptions. Accordingly, these descriptions are to be construed as illustrative only and are for the purpose of teaching those skilled in the art the best mode or modes presently contemplated for carrying out the invention. The details of the foregoing examples need not be mutually exclusive, as it is contemplated that each embodiment may incorporate features and structures as shown in the other embodiment. Finally, the details of the structure or structures disclosed herein may be varied substantially without departing from the spirit of the invention, and the exclusive use of all modifications which come within the scope of the appended claims, either literally or under the doctrine of equivalents, is reserved.

What is claimed:

1. A peel-off label assembly for application to a beverage bottle, the peel-off label assembly comprising:
a first panel manufactured from a first stock material, the first panel including:
a first side displaying a first group of indicia; and
a second side displaying a second group of indicia that is different than the first group of indicia;
a second panel manufactured from a second stock material that is different from the first stock material, the second panel including:
a first side displaying a third group of indicia that includes at least some of the first group of indicia; and
a second side;
a dry-peel adhesive releasably securing the second side of the first panel to the first side of the second panel; and
the second side of the second panel adapted to receive a second adhesive to permit securement of the second panel to the beverage bottle.

2. The label of claim 1, wherein the first panel and the second panel are substantially the same size with the first panel substantially superimposed over the second panel, and including a handle adapted to permit a user to grasp the first panel for removal.

3. The label of claim 1, further comprising a hold-out area formed in the peel adhesive, the hold-out arranged to permit at least a portion of the first panel to be grasped by a user.

4. The label of claim 1, wherein the first panel includes a tab arranged to permit the first panel to be grasped by a user.

5. The label of claim 1, wherein the second panel is a transparent material.

6. The label of claim 1, wherein the first stock material is a paper stock, and the second stock material is a coated one side stock.

7. The label of claim 1, wherein the first stock material is a foil stock.

8. A beverage bottle having a peel-off label assembly and comprising:
a bottle having an outer perimeter;
a peel-off label assembly, the peel-off label assembly including:
an inner panel having an inner face attached to the outer perimeter of the bottle by an adhesive;
an outer panel; and
a dry-peel adhesive releasably securing an inner face of the outer label to an outer face of the inner label.

9. The bottle of claim 8, wherein the outer panel includes an outer face displaying a first group of indicia and an inner face including a second group of indicia different than the first group of indicia.

10. The bottle of claim 9, the inner panel includes an outer face displaying a third group of indicia, the third group of indicia complementing the first group of indicia.

11. The bottle of claim 9, wherein second group of indicia comprises promotional product information.

12. The bottle of claim 8, when the outer panel is constructed of a first material panel and the inner panel is constructed of a second material different from the first material.

13. The bottle of claim 8, wherein the outer panel is proposed over the inner panel and the inner and outer panels are substantially the same size.

14. The bottle of claim 8, including a handle assembly of arranged to permit removal of the outer panel from the inner panel.

15. The bottle of claim 14, wherein the handle assembly includes at least one of a tab, and adhesive holdout area, or a notch formed in at least one of the panels.

16. A method of manufacturing a beverage bottle label for attachment to a beverage bottle, the method comprising the steps of:
providing a first panel manufactured from a first stock material;
providing a second panel manufactured from a second stock material that is different from the first stock material;
affixing the first panel to the second panel using a dry-peel adhesive; and
applying an adhesive to an exposed side of the second panel, the adhesive arranged to permit the second panel to be affixed to a beverage bottle.

17. The method of claim 16, further comprising the steps of printing a first side of the first panel with a first group of indicia pertaining to contents of the beverage bottle and printing a second side of the first panel with a second group of indicia that is different from the first group of indicia.

18. The method of claim 17, wherein the second group of indicia includes a coupon.

19. The method of claim 17, further comprising printing and outer face of the second panel with a third group of indicia, the third group of indicia substantially matching the first group of indicia.

20. The method of claim 16, wherein the inner panel comprises a transparent material.

21. The method of claim 16, including the step of forming a handle assembly arranged to permit grasping of the outer panel.

22. The method of claim 22, wherein a handle assembly is formed by at least one of a tab formed on the outer panel, a notch formed on either the outer panel or the inner panel, or an adhesive holdout area.

23. The method of claim 16, including the step of identifying a related product, and selecting indicia for printing on the inner face of the outer panel, the selected indicia relating to the related product.

24. A method of forming a beverage advertisement comprising the steps of:
providing a first label panel and a second label panel;
printing a first group of product indicia on a first side of the first label panel;
printing a second group of product information on a second side of the first label panel, wherein the second group of product indicia is different from the first group of product indicia;
releasably securing the second side of the first label panel to a first side of the second label panel using a dry-peel adhesive; and
applying an adhesive to a second side of the second label panel such that the second label can be secured to a receptacle.

25. The method of claim 24, wherein the second group of product indicia includes a coupon.

26. The method of claim 25, wherein printing the coupon includes printing a coupon related to a second product that is complementary to the product described by the first group of product indicia.

27. The method of claim 24, wherein the second label panel is a transparent material.

28. The method of claim 24, wherein the receptacle is a page adapted for insertion in a publication.

29. The method of claim 24, wherein printing the second group of product information includes printing information related to a second product that is complementary to the product described by the first group of product indicia.
